(19) United States
(12) Patent Application Publication
(10) Pub. No.: US 2006/0232824 A1
(43) Pub. Date: Oct. 19, 2006

(54) Novelty engraving device, system and method of operation

(76) Inventors: Webb T. Nelson, Woodinville, WA (US); Simeon E. Tiefel, Kenmore, WA (US)

Correspondence Address: LAMORTE & ASSOCIATES P.C., P.O. BOX 434, YARDLEY, PA, 19067, US

(21) Appl. No.: 11/107,716

(22) Filed: Apr. 18, 2005

(51) Int. Cl. B41C 1/04

(52) U.S. Cl. 358/3.29

(57) ABSTRACT

An engraving system that uses a child-safe engraving device and its associated method of operation. The child-safe engraving device includes a housing, where an engraving head selectively extends from the housing. The engraving head is positionable between an extended position, where the engraving head extends out of the housing, and a retracted position where the engraving head is retracted within the housing. A spring is used to bias the engraving head into its extended position. The engraving head moves into its retracted position when the engraving head is pressed against a surface with a force that surpasses the biasing force of the spring. A secondary object is provided that has at least one surface of malleable material. The malleable material is capable of being engraved by the engraving head using an application force that is less than that needed to retract the engraving head.

### BACKGROUND OF THE INVENTION

1. Field of the Invention

In general, the present invention relates to engraving devices that are used to engrave lines into a surface. More particularly, the present invention relates to novelty engravers that are intended to be used by children, having dull points, low power and the ability only to engrave only intended materials.

2. Background Art

The prior art is replete with various models and styles of powered engraving tools. Most commercial engraving tools have a hardened tip of carbide, diamond or steel that is sharpened to a cutting point. The tip of the engraver is then vibrated or reciprocated at very high speeds, often many thousands of cycled per minute. Commercial engravers are used to engrave marks onto hard steel surfaces such as tools, metal machine parts and the like.

Since commercial engravers have sharpened points that are moving at many thousands of cycles per second, engravers are inherently dangerous tools that should only be used by skilled adults that have a proper understanding of the engraver and its dangers. The use of such engravers also requires protective eyewear and other safety precautions. Commercial engravers should never be handled by children because such engravers could cause sever injury to any child who lacked the strength, skill and judgment to use the engraver safely.

In the novelty toy industry, safety is a leading concern. No toy manufacturer wants to create a toy that would harm a child. It is for this reason that toy manufactures have not created surface engravers and marketed those engravers to children. Rather, the only engraver-like toys that have been put in the marketplace are motorized pens that mark surfaces with ink. Such toys do not have cutting edges that can cause physical harm. However, marking ink on an object is not as interesting or as versatile as engraving a line into an object. A need therefore exists for an engraving system that can engrave specialized surfaces, yet cannot cut the skin or otherwise harm a child. A need also exists for such an engraver that can work on small toy batteries, is lightweight and operates at safe speeds, while still being able to engrave effectively. Such needs are met by the present invention device as described and claimed below.

### SUMMARY OF THE INVENTION

The present invention is an engraving system, the child-safe engraving device used in that system and its associated method of operation. The engraving system includes a child-safe engraving device and a secondary object with a malleable surface that can be engraved by the engraving device. The child-safe engraving device has a housing. An engraving head is used to terminate a rotating shaft. The engraving head is positionable between an extended position, where the engraving head extends out of the housing, and a retracted position where the engraving head is retracted within the housing. A spring is used to bias the engraving head into its extended position. The engraving head moves into its retracted position when the engraving head is pressed against a surface with a force that surpasses the biasing force of the spring. Consequently, the engraving head can only be pressed against a surface with a light force.

A secondary object is provided that has at least one surface of malleable material. The malleable material is capable of being engraved by the engraving head using an application force that is less than that needed to retract the engraving head.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a perspective view of an exemplary embodiment of the present invention engraving system;

FIG. 2 is a cross-sectional view of a first embodiment of the stylus section of the engraver;

FIG. 3 is a cross-sectional view of a second embodiment of the stylus section of the engraver; and

FIG. 4 is a front view of an exemplary embodiment of the engraver.

### DETAILED DESCRIPTION OF THE DRAWINGS

Although the present invention engraving system and device can be used to engrave many specialized surfaces, such as a doll, a toy vehicle, or the like, the present invention is particularly well suited for engraving specialized toy jewelry. Accordingly, the present invention is described in conjunction with specialized toy jewelry in order to set forth the best mode contemplated for the invention.

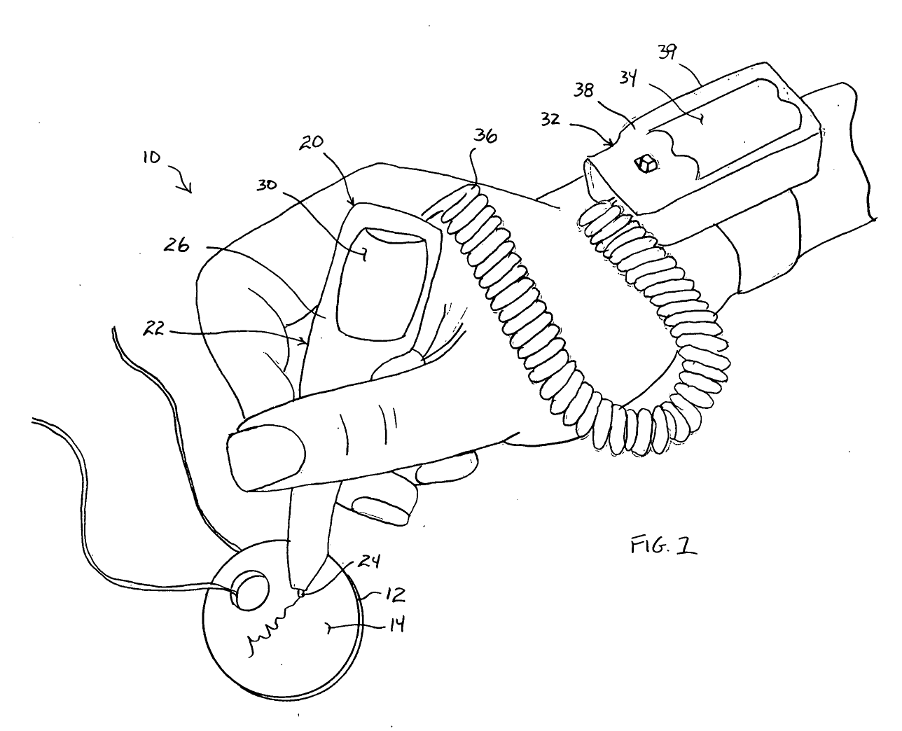

Referring to FIG. 1, an exemplary embodiment of an engraving system 10 is shown. The engraving system 10 includes a child-safe engraving device 20 and secondary objects 12 that are specifically designed to be engraved by the engraving device 20.

The engraving device 20 has two primary sections. The first section is the stylus section 22. An engraving head 24 extends from the stylus section 22. It is the engraving head 24 that contacts and physically engraves the secondary objects 12.

The stylus section 22 has an elongated housing 26 that can be easily held in a child's hand and manipulated against a surface in the same manner as a pencil or a pen. A motor 30 is held within the stylus housing 26. The motor 30 is a low power, low rotation and low cost motor that turns the engraving head 24 in a matter that is later explained.

The second section of the engraving device 20 is a power pack section 32. The power pack section 32 contains batteries 34 for powering the motor 30 within the stylus section 22. The stylus section 22 and the power pack section 32 are interconnected by a cable tether 36 that allows electrical power from the power pack section 32 to reach the motor 30 within the stylus section 22.

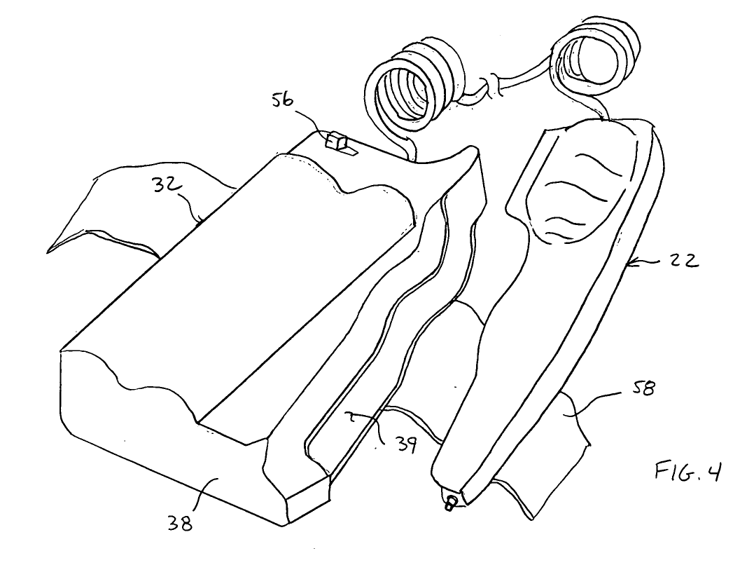

The power pack section 32 has a housing 38. The side of the housing is formed into a mounting seat 39. The housing 26 of the stylus section 22 is shaped to be received and engaged by the mounting seat 39. Thus, it will be understood that when the engraving device 12 is not in use, the stylus section 22 can be attached to the power pack section 32, as is later described with reference to FIG. 4.

The engraver device 20 can be sold as part of a larger engraving system 10 that includes objects 12 that are specifically designed to be engraved by the engraver device 20. In the exemplary embodiment shown, the objects 12 being engraved are pieces of costume jewelry. The costume jewelry has engraving surfaces 14 of ductile material that are specifically designed to be engraved by the engraving device 20. The ductile material can be plastic. However, soft metal alloys can also be used.

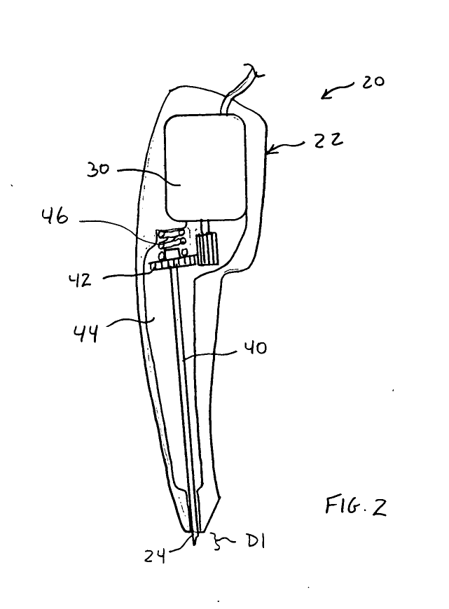

Referring to FIG. 2, it can be seen that within the stylus section 22 of the engraver device 20 is a shaft 40. The engraving head 24 is disposed at the tip of the shaft 40. The engraving head 24 can be a separate element that is attached to the end of the shaft 40. However, in the preferred embodiment, the engraving head 24 is formed into the tip of the shaft 40. The engraving head 24 shown is formed by creating a lap cut in the end of the shaft 40, wherein about half of the shaft end is removed. This forms a flat face having side edges that can cut soft material.

A motor 30 rotates the shaft 40. The shaft 30 can be directly rotated by the motor 30. However, in the shown embodiment, a small gear arrangement 42 can be provided in between the shaft 40 and the motor 30. The gear arrangement 42 can either increase the power of the motor 30 and decrease the rotational speed of the shaft 40, or decrease the power of the motor 30 and increase the rotational speed of the shaft 40. The selection of the gear arrangement 42 depends upon the power and rotational speed of the motor 30 that is selected.

The shaft 40 is set within an internal chamber 44. The shaft 40 is free to move reciprocally along the length of the internal chamber 44. The shaft 40 is biased forward in the internal chamber 44 by a spring 46. The motor 30 is directly connected to the shaft 40 by the gear arrangement 42. However, the gear arrangement 42 allows the shaft 40 to reciprocally move while it is being turned by the motor 30. Thus, when the shaft 40 is pressed against an object, the shaft 40 is pushed against the bias of the spring 46.

The engraving head 24 extends out of the stylus housing 26 by a predetermined distance D1. However, the spring 46 can be compressed by a second distance that is longer than that first distance D1. Thus, when the engraving head 24 is being used and is pressed against an object, the engraving head 24 contacts that object with a force no greater than the bias provided by the spring 46. If the engraving head 24 is pressed too hard against any surface, the engraving head 24 will retract into the stylus housing 26 and the engraving process will stop. It will therefore be understood that the engraving head 24 can be selectively moved between an extended position and a retracted position. The engraving head 24 is biased into the extended position by the spring 46. But when the engraving head 24 is pressed against a surface during an engraving operation, the engraving head 24 can only be pressed against a surface with a maximum predetermined force that is controlled by the bias strength of the spring 46. The engraving head 24, therefore, cannot be brought to a stop by being forced into material too aggressively. Rather, the engraving head 24 will only protrude and engrave material if applied to a surface with the proper force. The engraving head 24 will retreat into the stylus housing 26 prior to experiencing any forces sufficient to stop the rotation of the engraving head 24. As a consequence, although a relatively small, low powered motor 30 is being used, the motor 30 cannot be readily stopped during engraving.

The bias of the spring 46 is designed to be less than the force needed to cause the engraving head 24 to puncture or otherwise cut into human skin. Thus, if the engraving head 24 is brought into contact with skin, the engraving head 24 will retreat into the stylus housing 26 prior to being able to cut into the skin.

In any event, when the engraving head 24 is fully extended the distance D1 from the stylus housing, that distance is less than one millimeter. This distance is less than the thickness of the top dermis layer of the skin of as child. Accordingly, even if the engraving head 24 were stuck in its fully extended position, the engraving head 24 does not extend outwardly enough to pierce the skin down to a level that can cause bleeding. The engraving head 24 is therefore harmless when brought into contact with most all areas of skin.

Furthermore, the motor 30 and gears are arranged to provide a low rotation to the engraving head. The engraving head 24 preferably rotates at a speed of less than five hundred cycles per minute, which is more than ten times slower than a traditional engraver. At this rotational speed, the engraving head 24 lacks the kinetic energy necessary to pass through skin, thereby making the cutting of the skin unlikely.

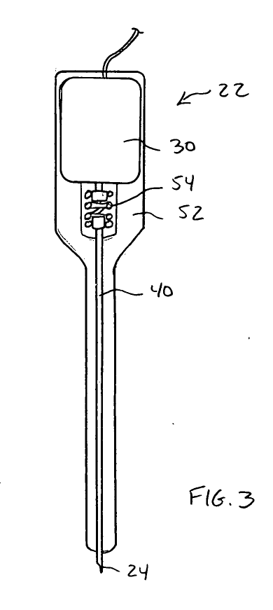

Referring to FIG. 3, an alternate embodiment of the stylus section 22 of the engraver device is shown. For the sake of clarity, parts identical to those used in the embodiment of FIG. 2 are identified with the same reference numbers. In FIG. 3, the motor 30 is set in a fixed position within the stylus housing 52. The shaft 40 is indirectly connected to the motor 30 by a spring 54. The motor 30 turns the spring 54, which turns the shaft 40. However, the shaft 40 is free to move reciprocally within the stylus housing 52. Thus, the engraving head 24 of the shaft 40 will retreat into the stylus housing 52, if the engraving head 24 experiences a force that surpasses the bias presented by the spring 54. The engraving head 24 will only protrude and engrave material if applied to a surface with the proper force. Furthermore, the bias of the spring 54 is designed to be less than the force needed to cause the engraving head 24 to puncture or otherwise cut into human skin. Consequently, if the engraving head 24 is brought into contact with skin, the engraving head 24 will retract into the stylus housing 26 prior to being able to cut into the skin.

Referring to FIG. 4, it can be seen that the stylus section 22 of the engraving device 12 mates with the power pack section 32 of the engraving device 12 when not in use. The power pack section 32 of the engraving device 12 has a mounting seat 39 formed into its housing 38 that receives and engages the stylus section 22.

Batteries are held within the power pack section 32. An on/off switch 56 is also provided for selectively turning on and off the motor that is contained within the stylus section 22.

An adjustable strap 58 is provided that attaches to the housing 38 of the power pack section 32. The strap 58 enables the power pack section 32 of the engaging device 12 to be selectively bound to a person's wrist, as was previously illustrated in FIG. 1.

It will be understood that the embodiments of the present invention that are illustrated and described are merely exemplary and that a person skilled in the art can make many variations to those embodiments, For instance that shape of the stylus housing and the power pack housing are a matter of design choice. Furthermore, the batteries for powering the motor can be contained in the stylus with the motor, thereby eliminating the need for the wire tether. All such modifications, variations and alternate embodiments are intended to be included within the scope of the present invention as set forth by the claims.

What is claimed is:

1. A novelty engraving device, comprising:
a housing;
a shaft having a first end, wherein said shaft is positionable between and extended position, where said first end of said shaft extends out of said housing, and a retracted position where said first end of said shaft is retracted within said housing;
a motor for turning said shaft; and
a spring for biasing said a shaft into said extended position with a predetermined biasing force, wherein said shaft moves from said extended position toward said retracted position when said first end of said shaft is pressed against a surface with a force that surpasses said predetermined biasing force.

2. The device according to claim 1, wherein said first end first end of said shaft terminates with an engraving head.

3. The device according to claim 1, wherein said motor is coupled to said shaft and moves with said shaft as said shaft moves between said extended position and said retracted position.

4. The device according to claim 1, wherein said motor rotates said spring and said spring rotates said shaft.

5. The device according to claim 1, further including a battery power pack for providing electrical power to said motor.

6. The device according to claim 5, wherein said battery power pack is not contained within said housing, but is attached to said housing by a wire tether.

7. The device according to claim 6, wherein said battery power pack further includes a wrist strap for attaching said battery power pack to a person's wrist.

8. The device according to claim 6, wherein said housing and said battery power pack selectively attachable and detachable.

9. A novelty engraving system, comprising:
a motorized engraver having a stylus section, a motor retained within said stylus section and a engraving head that is rotated by an electric motor, wherein said engraving head extends from said stylus section by no more than one millimeter; and
at least one novelty object having at least one surface of material that can be readily engraved by said engraving head of said motorized engraver.

10. The system according to claim 9, wherein said motorized engraver includes a power pack section that is interconnected to said stylus section by a flexible wire cable.

11. The system according to claim 9, wherein said electric motor turns said engraving head at a rotational speed less than five hundred revolutions per minute.

12. The system according to claim 10, wherein batteries for powering said electric motor are disposed in said power pack section of said motorized engraver.

13. The system according to claim 9, wherein said motorized engraver includes a shaft, wherein said electric motor turns said shaft and said engraving head is disposed at an end of said shaft.

14. The system according to claim 13, wherein said engraving head is biased into an extended position by a spring.

15. The system according to claim 14, wherein said spring is disposed between said electric motor and said shaft.

16. The system according to claim 9, wherein said engraving head is a dull safety tip that cannot cut skin and said at least one surface of material on said novelty object is highly ductile and engravable by said engraving head.

17. A method of operation for a novelty engraving system that has an engraving head and a motor for rotating the engraving head, said method comprising the steps of:
having the engraving head be selectively positionable between a retracted position, where said engraving head is not exposed, and an extended position, where said engraving head is exposed, wherein said engraving head is biased into said extended position by a spring that provides predetermined bias force; and
providing a malleable surface that can be engraved by said engraving head when said engraving head is pressed against said malleable surface with a force less than said predetermined force.
